(19) United States
(12) Patent Application Publication
(10) Pub. No.: US 2015/0024283 A1
(43) Pub. Date: Jan. 22, 2015

(54) NON-AQUEOUS ELECTROLYTE FOR SECONDARY BATTERIES, AND NON-AQUEOUS ELECTROLYTE SECONDARY BATTERY

(71) Applicant: PANASONIC CORPORATION, Osaka (JP)

(72) Inventor: Masaki Deguchi, Tokushima (JP)

(21) Appl. No.: 14/376,013

(22) PCT Filed: Apr. 11, 2013
(86) PCT No.: PCT/JP2013/002470

§ 371 Date: Jul. 31, 2014

(30) Foreign Application Priority Data
Apr. 11, 2012 (JP) 2012-090526

(51) Int. Cl. H01M 10/0569; H01M 4/50; H01M 10/0525; H01M 4/52

(52) U.S. Cl. CPC H01M 10/0569; H01M 4/523; H01M 4/502; H01M 10/0525; H01M 2300/0042
USPC 429/332

(57) ABSTRACT

Provided is a non-aqueous electrolyte for secondary batteries which is capable of maintaining excellent discharge characteristics even at low temperatures. The non-aqueous electrolyte for secondary batteries includes a non-aqueous solvent, and a lithium salt dissolved in the non-aqueous solvent. The non-aqueous solvent includes a cyclic carbonate, a chain carbonate, a fluoroarene, and a carboxylic acid ester. The cyclic carbonate includes ethylene carbonate. The non-aqueous solvent has a cyclic carbonate content M_{CI} of 4.7 to 90 mass %, an ethylene carbonate content M_{EC} of 4.7 to 37 mass %, a chain carbonate content M_{CH} of 8 to 80 mass %, a fluoroarene content M_{FA} of 1 to 25 mass %, and a carboxylic acid ester content M_{CAE} of 1 to 80 mass %.

### TECHNICAL FIELD

The present invention relates to a non-aqueous electrolyte for secondary batteries, and a non-aqueous electrolyte secondary battery, and particularly relates to an improvement of a non-aqueous electrolyte including a cyclic carbonate such as ethylene carbonate (EC) and a chain carbonate.

### Background Art

In non-aqueous electrolyte secondary batteries represented by lithium ion secondary batteries, a non-aqueous solvent solution of lithium salt is used as a non-aqueous electrolyte. The non-aqueous solvent is, for example, a cyclic carbonate such as EC and propylene carbonate (PC), and a chain carbonate such as ethyl methyl carbonate (EMC), dimethyl carbonate (DMC), and diethyl carbonate (DEC). In general, two or more carbonates are usually used in combination. Moreover, to improve battery characteristics, an additive is conventionally added to the non-aqueous electrolyte.

For example, Patent Literature 1, in view of improving initial power generation efficiency and charge/discharge cycle characteristics, uses a non-aqueous electrolyte which includes 10 to 60 vol % of PC, 1 to 20 vol % of EC, and 30 to 85 vol % of a chain carbonate such as DEC, and to which 1,3-propane sultone and vinylene carbonate are added.

### CITATION LIST

### Patent Literature

### [PTL 1] Japanese Laid-Open Patent Publication No. 2004-355974

### SUMMARY OF INVENTION

### Technical Problem

EC, among cyclic carbonates, has a high dielectric constant, but because of its comparatively high melting point, tends to be highly viscous at low temperatures. Therefore, the viscosity of a non-aqueous electrolyte including such EC is easily increased. The increase in viscosity of the non-aqueous electrolyte is large particularly at low temperatures, and at low temperatures, the ion conductivity is reduced, easily leading to deterioration in discharge characteristics.

When the non-aqueous electrolyte is highly viscous, it cannot be injected smoothly into the battery case, and moreover, cannot easily penetrate into an electrode group including positive and negative electrodes. If the non-aqueous electrolyte is not allowed to evenly penetrate into the electrode group, metal lithium is likely to deposit unevenly on the surface of the negative electrode in the event of overcharge. The deposited metal lithium is very unstable, and highly reactive to non-aqueous solvent, which may facilitate further gas generation. In addition, the locally-deposited metal lithium can cause heat generation, which may degrade the safety of the battery.

Furthermore, a chain carbonate such as DEC is likely to generate gas when oxidatively decomposed or reductively decomposed. In Patent Literature 1, because of the inclusion of a large amount of chain carbonate such as DEC, a large amount of gas will be generated. Particularly when the battery is stored in a high temperature environment, or repetitively charged and discharged, a large amount of gas is likely to be generated. The generation of a large amount of gas may lower the charge/discharge capacity of the battery, as well as deteriorate the discharge characteristics. Particularly at low temperatures, the ion conductivity tends to be reduced, which is combined with a reduction in the capacity associated with gas generation, to cause the discharge characteristics to deteriorate significantly.

An object of the present invention is to provide a non-aqueous electrolyte for secondary batteries and a non-aqueous electrolyte secondary battery which are capable of maintaining excellent discharge characteristics even at low temperatures.

### Solution to Problem

One aspect of the present invention is a non-aqueous electrolyte for secondary batteries, including a non-aqueous solvent, and a lithium salt dissolved in the non-aqueous solvent. The non-aqueous solvent includes a cyclic carbonate, a chain carbonate, a fluoroarene, and a carboxylic acid ester. The cyclic carbonate includes EC. The non-aqueous solvent has a cyclic carbonate content M_{CI} of 4.7 to 90 mass %, an EC content M_{EC} of 4.7 to 37 mass %, a chain carbonate content M_{CH} of 8 to 80 mass %, a fluoroarene content M_{FA} of 1 to 25 mass %, and a carboxylic acid ester content M_{CAE} of 1 to 80 mass %.

Another aspect of the present invention is a non-aqueous electrolyte secondary battery including: a positive electrode having a positive electrode current collector, and a positive electrode active material layer formed on a surface of the positive electrode current collector; a negative electrode having a negative electrode current collector, and a negative electrode active material layer formed on a surface of the negative electrode current collector; a separator interposed between the positive electrode and the negative electrode; and the aforementioned non-aqueous electrolyte for secondary batteries.

### Advantageous Effects of Invention

According to the present invention, in non-aqueous electrolyte secondary batteries, the discharge characteristics at low temperatures can be improved.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING

FIG. 1 A partially cut-away oblique view of a prismatic non-aqueous electrolyte secondary battery according to one embodiment of the present invention.

### DESCRIPTION OF EMBODIMENTS

### Non-Aqueous Electrolyte

A non-aqueous electrolyte for secondary batteries of the present invention includes a non-aqueous solvent, and a lithium salt dissolved in the non-aqueous solvent. The non-aqueous solvent includes a cyclic carbonate, a chain carbonate, a fluoroarene, and a carboxylic acid ester. The cyclic carbonate includes EC. The non-aqueous solvent has a cyclic carbonate content M_{CI} of 4.7 to 90 mass %, an EC content M_{EC} of 4.7 to 37 mass %, a chain carbonate content M_{CH} of 8 to 80 mass %, a fluoroarene content M_{FA} of 1 to 25 mass %, and a carboxylic acid ester content M_{CAE} of 1 to 80 mass %.

In the non-aqueous electrolyte of the present invention, the non-aqueous solvent of the non-aqueous electrolyte includes a cyclic carbonate including EC, and a chain carbonate, and in addition to them, a fluoroarene, and a carboxylic acid ester, each in an amount as described above. Therefore, even when the cyclic carbonate content is comparatively high, the increase in viscosity of the non-aqueous electrolyte can be suppressed even at low temperatures. Since the viscosity of the non-aqueous electrolyte can be kept low even at low temperatures, the excellent discharge characteristics at low temperatures can be maintained. Furthermore, since the decomposition of the chain carbonate can be easily suppressed, the gas generation can be reduced. This also serves to suppress the capacity degradation, as well as to suppress the deterioration in discharge characteristics (particularly, the low-temperature discharge characteristics).

Using a carboxylic acid ester in a specific amount can improve the ability of the non-aqueous electrolyte to wet the electrodes and separator, and can remarkably facilitate the penetration of the non-aqueous electrolyte into the electrodes and separator. Accordingly, the non-aqueous electrolyte can be injected smoothly into the battery case accommodating the electrodes and the separator. Due to the improved wetting ability, the overvoltage becomes low, and the deposition of metal lithium is reduced. In addition, since the non-aqueous electrolyte can easily penetrate into the electrodes and separator evenly, if metal lithium is deposited, the individual crystals thereof are small and uniform, and the fluoroarene can easily react therewith. This means that the deposited metal lithium, if any, will quickly react with the fluoroarene, and is likely to be stabilized. Therefore, even in the event of overcharge, the reaction of the metal lithium and the non-aqueous solvent such as chain carbonate is inhibited, which can reduce the gas generation, as well as can suppress the heat generation caused by the metal lithium. Consequently, the battery safety can be improved.

It is to be noted that when the non-aqueous electrolyte does not include a carboxylic acid ester, the penetration of the non-aqueous electrolyte into the electrodes and the separator is not good. When the penetration of the non-aqueous electrolyte is not good, the overvoltage becomes comparatively high, and the non-aqueous electrolyte fails to penetrate evenly, creating areas where the non-aqueous electrolyte is not retained. In such a case, the capacity is lowered, and the discharge characteristics (particularly, the low-temperature discharge characteristics) tend to deteriorate. Furthermore, absorption and release of lithium associated with charge and discharge become uneven, and consequently, particularly in the event of overcharge, metal lithium is likely to be deposited locally on the surface of the negative electrode. The metal lithium, if deposited locally, tends to have a large crystal size. Therefore, even though the non-aqueous electrolyte includes a fluoroarene, the fluoroarene is difficult to react with the metal lithium, and the metal lithium is difficult to be stabilized, resulting in a significant degradation of the battery safety.

In contrast, in the present invention, in addition to a cyclic carbonate including EC and a chain carbonate, a fluoroarene and a carboxylic acid ester are used in combination, each in a specific amount. Therefore, as compared with when the non-aqueous electrolyte does not include a carboxylic acid ester and includes a fluoroarene, the discharge characteristics (particularly, the low-temperature discharge characteristics) can be improved. Moreover, the overcharge tolerance can also be significantly improved.

Furthermore, on a mass-production line and the like, in general, non-aqueous electrolyte tends to solidify at the nozzle used for its injection, causing variations in the amount of injected electrolyte among batteries. When the penetration of non-aqueous electrolyte is not good, the amount of non-aqueous electrolyte in some batteries may fall short of a predetermined amount. When such batteries are repetitively charged and discharged, the battery characteristics tend to deteriorate. However, in the present invention, the penetration of non-aqueous electrolyte is good, and therefore, such deterioration in battery characteristics can be suppressed.

### (Cyclic Carbonate)

The cyclic carbonate includes EC. The cyclic carbonate specifically means a cyclic carbonate that does not contain a polymerizable carbon-carbon unsaturated bond and/or fluorine atom. In addition to EC, the cyclic carbonate may contain a cyclic carbonate other than EC. An example of the cyclic carbonate other than EC is an alkylene carbonate having 4 or more carbon atoms, such as PC and butylene carbonate. The number of carbon atoms in this alkylene carbonate is preferably 4 to 7, and more preferably 4 to 6. These cyclic carbonates other than EC may be used singly, or in combination of two or more. The cyclic carbonate preferably includes EC and PC. PC, although tending to increase the viscosity of the non-aqueous electrolyte, is suitable as a non-aqueous solvent for non-aqueous electrolyte because it is highly electrically conductive. The cyclic carbonate may include EC only, or may include EC and PC only.

The cyclic carbonate content M_{CI} in the non-aqueous solvent is 4.7 mass % or more (e.g., 5 mass % or more), preferably 20 mass % or more, and more preferably 25 mass % or more, or 30 mass % or more. M_{CI} is 90 mass % or less, preferably 80 mass % or less, and more preferably 75 mass % or less. These lower limits and upper limits can be combined in any combination. M_{CI} may be, for example, 5 to 90 mass %, 20 to 80 mass %, or 25 to 75 mass %. When M_{CI} is less than 4.7 mass %, the ion conductivity of the non-aqueous electrolyte is likely to be insufficient, and the discharge characteristics tend to deteriorate. When M_{CI} is more than 90 mass %, the non-aqueous electrolyte is likely to become highly viscous, leading to a reduced ion conductivity at low temperatures and a reduced penetration of non-aqueous electrolyte into the electrodes and separator, which consequently deteriorate the discharge characteristics. In addition, the reduced penetration of non-aqueous electrolyte makes it difficult to ensure the safety in the event of overcharge.

(EC)

The EC content M_{EC} in the non-aqueous solvent is 4.7 mass % or more, preferably 5 mass % or more (e.g., 7 mass % or more), and more preferably 10 mass % or more. M_{EC} is 37 mass % or less, preferably 35 mass % or less (e.g., 32 mass % or less), and more preferably 30 mass % or less. These lower limits and upper limits can be appropriately selected and combined. M_{EC} may be, for example, 5 to 35 mass %, or 10 to 30 mass %.

When M_{EC} is more than 37 mass %, the viscosity of the non-aqueous electrolyte is increased, and the penetration of the non-aqueous electrolyte into the electrodes and separator is reduced. As a result, the discharge characteristics at low temperatures are degraded, and the safety in the event of overcharge is reduced. Moreover, EC is oxidatively decomposed at the positive electrode, to facilitate gas generation, and form a surface film which is thicker than necessary on the negative electrode, increasing the resistance. When M_{EC} is less than 4.7 mass %, the ion conductivity of non-aqueous electrolyte is lowered, and the rate characteristics degrade.

(PC)

When the non-aqueous solvent includes PC, a PC content M_{PC} in the non-aqueous solvent is, for example, 1 mass % or more, preferably 10 mass % or more, and more preferably 20 mass % or more. M_{PC} is, for example, 60 mass % or less, and preferably 50 mass % or less. These lower limits and upper limits can be appropriately selected and combined. M_{PC} may be, for example, 1 to 60 mass %, 1 to 50 mass %, or 20 to 60 mass %.

When M_{PC} is within the above range, it is possible to more effectively suppress the deterioration in discharge characteristics at low temperatures due to an increase in the viscosity of the non-aqueous electrolyte and a reduced penetration of the non-aqueous electrolyte into the electrodes and separator. Furthermore, it is possible to prevent the amount of other components such as a chain carbonate from becoming excessively high relatively. Therefore, the oxidative decomposition and reductive decomposition of the non-aqueous solvent can be easily suppressed, and the gas generation can be effectively reduced.

In a secondary battery including the non-aqueous electrolyte, the PC content M_{PC} may be adjusted according to the type of the positive electrode active material. For example, when the positive electrode active material is a lithium nickel oxide as described hereinafter, the PC content M_{PC} in the non-aqueous solvent may be, for example, 30 to 60 mass %, and preferably 40 to 60 mass %. When the positive electrode active material is a lithium cobalt oxide as described hereinafter, the PC content M_{PC} in the non-aqueous solvent may be, for example, 1 to 40 mass %, and preferably 1 to 30 mass %.

### (Chain Carbonate)

The chain carbonate decreases the viscosity of the non-aqueous electrolyte, making it easy to ensure a high ion conductivity. An example of the chain carbonate is a dialkyl carbonate, such as EMC, DMC, and DEC. These chain carbonates may be used singly or in combination of two or more. The number of carbon atoms in each of the alkyl groups constituting the dialkyl carbonate is preferably 1 to 4, and more preferably 1 to 3. The chain carbonate preferably includes DEC. The chain carbonate may include DEC and a chain carbonate other than DEC (e.g., EMC and/or DMC). The chain carbonate may include DEC only, which is also preferable.

The chain carbonate content M_{CH} in the non-aqueous solvent is 8 mass % or more, preferably 9 mass % or more, and more preferably 10 mass % or more. M_{CH} is 80 mass % or less, preferably 70 mass % or less, and more preferably 65 mass % or less, or 60 mass % or less. These lower limits and upper limits can be combined in any combination. M_{CH} is, for example, 8 to 80 mass %, 10 to 80 mass %, or 10 to 70 mass %.

When M_{CH} is more than 80 mass %, the chain carbonate is oxidatively decomposed or reductively decomposed remarkably, to generate a large amount of gas. If a large amount of gas is generated, gas enters between the positive electrode and the negative electrode, to partially widen the space between the electrodes plates. Charge and discharge are difficult to proceed at the widened portion between the electrode plates. This lowers the charge/discharge capacity, and thus deteriorates the discharge characteristics. The deterioration in discharge characteristics, combined with the reduction in ion conductivity, tends to be remarkable at low temperatures. Moreover, the area of electrode surface where charge and discharge can proceed is decreased, causing the impedance to increase and the rate characteristics to deteriorate. Note that the gas generation becomes remarkable when the battery is stored at high temperatures or as the battery is charged and discharged repetitively. When M_{CH} is less than 8 mass %, the cyclic carbonate content becomes relatively high, which increases the viscosity of the non-aqueous electrolyte, and reduces the penetration of the non-aqueous electrolyte into the electrodes and separator. This deteriorates the discharge characteristics at low temperatures and reduces the safety in the event of overcharge.

(DEC)

When the non-aqueous solvent includes DEC, a DEC content M_{DEC} in the non-aqueous solvent is 10 mass % or more, preferably 20 mass % or more, and more preferably 30 mass % or more. M_{DEC} is 60 mass % or less, and preferably 55 mass % or less. These lower limits and upper limits can be appropriately selected and combined. M_{DEC} may be, for example, 20 to 60 mass %, or 20 to 55 mass %.

When M_{DEC} is within the above range, the oxidative decomposition and reductive decomposition of DEC can be inhibited, and thereby the generation of a large amount of gas can be suppressed. Therefore, the reduction in charge/discharge capacity associated with gas generation can be more effectively suppressed. Note that the gas generation becomes significant when the battery is stored at high temperatures or as the battery is charged and discharged repetitively. Furthermore, the increase in impedance can be suppressed, and therefore, the deterioration in rate characteristics can be suppressed. Moreover, the increase in the viscosity of the non-aqueous electrolyte and the deterioration in the penetration of the non-aqueous electrolyte into the electrodes and separator are inhibited. Therefore, the deterioration in discharge characteristics at low temperatures and the reduction in safety in the event of overcharge can be more effectively suppressed.

### (Fluoroarene)

Examples of the fluoroarene included in the non-aqueous solvent include: fluorobenzenes, such as monofluorobenzene (FB), difluorobenzene, and trifluorobenzene; alkyl benzenes having a fluorine atom in its benzene ring, such as fluorotoluenes such as monofluorotoluene and difluorotoluene, and monofluoroxylene; and fluoronaphthalenes, such as monofluoronaphthalene. These may be used singly or in combination of two or more. It is preferable to use at least one selected from the group consisting of fluorobenzenes and fluorotoluenes, as the fluoroarene.

In the fluoroarene, the number of fluorine atoms can be appropriately selected, depending on the number of carbon atoms on the arene ring, the number of alkyl groups as a substituent on the arene ring, and other factors. In fluorobenzenes, the number of fluorine atoms is 1 to 6, preferably 1 to 4, and more preferably 1 to 3. In fluorotoluenes, the number of fluorine atoms is 1 to 5, preferably 1 to 3, and more preferably 1 or 2.

The fluoroarene content M_{FA} in the non-aqueous solvent is 1 mass % or more, preferably 2 mass % or more, and more preferably 5 mass % or more, or 7 mass % or more. M_{FA} is 25 mass % or less, preferably 20 mass % or less, and more preferably 15 mass % or less. These lower limits and upper limits can be combined in any combination. M_{FA} may be, for example, 1 to 25 mass %, 2 to 25 mass %, 2 to 15 mass %, or 7 to 20 mass %.

When M_{FA} is more than 25 mass %, the ion conductivity is reduced, and the low-temperature discharge characteristics or the rate characteristics are deteriorated. When M_{FA} is less than 1 mass %, a synergetic effect produced by combining the fluoroarene with a branched-chain alkane carboxylic acid ester is difficult to obtain. In view of suppressing the reduction in safety in the event of overcharge, M_{FA} is preferably 2 mass % or more.

### (Carboxylic Acid Ester)

The carboxylic acid ester is, for example, a chain carboxylic acid ester, or a cyclic carboxylic acid ester (e.g., γ-butyrolactone, and γ-valerolactone). Examples of the chain carboxylic acid ester include: straight-chain alkane carboxylic acid esters (e.g., alkyl esters of straight-chain alkane carboxylic acids), such as methyl acetate, methyl propionate, and methyl butyrate; and branched-chain alkane carboxylic acid esters (e.g., alkyl esters of branched-chain alkane carboxylic acids), such as methyl isobutyrate. The straight-chain or branched-chain alkane carboxylic acid ester may have a substituent (e.g., a halogen atom such as fluorine atom, a hydroxyl group, and an alkoxy group) in the alkane moiety of the alkane carboxylic acid, or in the alkyl group bound to the oxygen (—O—) in the carbonyl oxy group. These carboxylic acid esters may be used singly or in combination of two or more.

For easy obtainment of excellent low-temperature discharge characteristics, the carboxylic acid ester preferably includes a chain carboxylic acid ester. For further suppression of gas generation, the carboxylic acid ester preferably includes a branched-chain alkane carboxylic acid ester. The carboxylic acid ester may include a branched-chain alkane carboxylic acid ester and another carboxylic acid ester, or may include a branched-chain alkane carboxylic acid only.

The carboxylic acid ester content M_{CAE} in the non-aqueous solvent is 1 mass % or more, preferably 1.8 mass % or more, and more preferably 2 mass % or more, or 2.5 mass % or more. M_{CAE} is preferably 80 mass % or less, preferably 60 mass % or less (e.g., 40 mass % or less), and more preferably 25 mass % or less, or 10 mass % or less. These lower limits and upper limits can be combined in any combination. M_{CAE} may be, for example, 1 to 80 mass %, 1.8 to 40 mass %, or 2 to 25 mass %.

When M_{CAE} is less than 1 mass %, the viscosity of the non-aqueous electrolyte cannot be sufficiently lowered, and the ability of the non-aqueous electrolyte to wet the electrodes and separator is degraded, failing to obtain the synergetic effect with the fluoroarene. When M_{CAE} is more than 80 mass %, the ion conductivity is easily reduced, and the discharge characteristics deteriorate. Moreover, the carboxylic acid ester is easily oxidatively decomposed or vaporized, to generate a large amount of gas. If a large amount of gas is generated, the charge/discharge capacity is lowered, and the rate characteristics are degraded.

(Branched-Chain Alkane Carboxylic Acid Ester)

The branched-chain alkane carboxylic acid ester means an alkane carboxylic acid ester in which the alkyl group bound to the carbon atom in the carbonyl group (—C(═O)—) is a branched-chain alkyl group. The carbon atom in the alkyl group bound to the carbon atom in the carbonyl group may be a secondary carbon atom, or a tertiary carbon atom. For easy obtainment of the synergetic effect with the fluoroarene, the carbon atom in the alkyl group bound to the carbon atom in the carbonyl group is preferably a tertiary carbon atom. Specifically, the branched-chain alkane carboxylic acid ester in which the carbon atom in the alkyl group bound to the carbon atom in the carbonyl group is a tertiary carbon atom is, for example, one represented by the following formula (1):

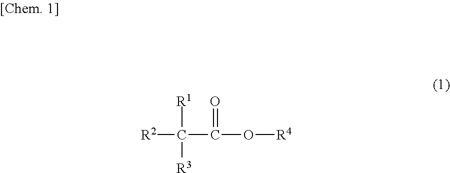

where R¹ to R⁴ independently represent an alkyl group or a halogenated alkyl group.

In the formula (I), the alkyl groups represented by R¹ to R⁴ are, for example, straight-chain or branched-chain alkyls, such as methyl, ethyl, n-propyl, isopropyl, n-butyl, isobutyl, and t-butyl groups.

The halogenated alkyl groups represented by R¹ to R⁴ are, for example, those corresponding to the above alkyl groups and having, as a halogen atom, a fluorine, a chlorine, a bromine and/or an iodine atom. The halogen atom is preferably a fluorine atom and/or a chlorine atom.

For example, when the halogen atom is a fluorine atom, examples of the halogenated alkyl group includes monofluoromethyl, difluoromethyl, trifluoromethyl, 2-monofluoroethyl, 2,2-difluoroethyl, 2,2,2-trifluoroethyl, and perfluoroethyl groups. In the halogenated alkyl group, all or some of the hydrogen atoms in the alkyl group may be substituted by the halogen atom.

R¹ to R⁴ have, for example, 4 to 8 carbon atoms, preferably 4 to 6 carbon atoms, and more preferably 4 or 5 carbon atoms in total. The alkyl group independently represented by R¹ to R⁴ is, for example, a C₁₋₄alkyl group, preferably a C₁₋₂alkyl group, and more preferably a methyl group. The halogenated alkyl group is, for example, a halogenated C₁₋₄alkyl group, preferably a halogenated C₁₋₂alkyl group, and more preferably a halogenated methyl group. All of R¹ to R⁴ are preferably selected from the group consisting of a C₁₋₂alkyl group and a halogenated C₁₋₂alkyl group. Particularly preferably, all of R¹ to R⁴ are a C₁₋₂alkyl group (particularly, a methyl group). The branched-chain alkane carboxylic acid ester in which all of R¹ to R⁴ are a methyl group is methyl pivalate (MTMA).

When the carboxylic acid ester includes a branched-chain alkane carboxylic acid ester, a branched-chain alkane carboxylic acid ester content M_{ABAC} in the non-aqueous solvent is, for example, 1 mass % or more, preferably 2 mass % or more, and more preferably 2.5 mass % or more, or 3 mass % or more. M_{ABAC} is, for example, 40 mass % or less, preferably 30 mass % or less (e.g., 25 mass % or less), and more preferably 15 mass % or less, or 10 mass % or less. These lower limits and upper limits can be combined in any combination. M_{ABAC} may be, for example, 1 to 40 mass %, 2 to 25 mass %, 2 to 15 mass %, or 2.5 to 10 mass %.

Using a branched-chain alkane carboxylic acid ester is advantageous in decreasing the viscosity of the non-aqueous electrolyte and improving the ability of the non-aqueous electrolyte to wet the electrodes and separator. However, a branched-chain alkane carboxylic acid ester is low in oxidation resistance and low in vapor pressure, and is likely to generate gas. Therefore, it is preferable to use a branched-chain alkane carboxylic acid ester in the amount within the range as above. When M_{ABAC} is in the above range, the gas generation resulted from oxidative reduction and vaporization of the branched-chain alkane carboxylic acid ester can be more effectively suppressed, whereby the reduction in charge/discharge capacity and rate characteristics can be easily suppressed. Furthermore, since the viscosity of the non-aqueous electrolyte can be easily decreased, the ability of the non-aqueous electrolyte to wet the electrodes and separator can be less likely to be reduced, and the synergetic effect with the fluoroarene can be easily obtained.

### (Other Solvents)

The non-aqueous solvent may contain at least one solvent other than the above, if necessary. Examples of such other solvents include: chain ethers, such as 1,2-dimethoxyethane; and cyclic ethers, such as tetrahydrofuran, 2-methyltetrahydrofuran, and 1,3-dioxolane. These other solvents may be used singly or in combination of two or more. The amount of other solvent(s) in the whole non-aqueous solvent is, for example, 10 mass % or less, and preferably 5 mass % or less.

(Additive)

The non-aqueous electrolyte may contain any known additive, if necessary, examples of which include: cyclic carbonates having a polymerizable carbon-carbon unsaturated bond, such as vinylene carbonate and vinyl ethylene carbonate; cyclic carbonates having a fluorine atom, such as fluoroethylene carbonates; sultone compounds, such as 1,3-propane sultone; sulfonate compounds, such as methylbenzene sulfonate; and aromatic compounds (e.g., aromatic compounds having no fluorine atom), such as cyclohexylbenzene, biphenyl, and diphenyl ether. These additives may be used singly or in combination of two or more.

The amount of additive(s) in the whole non-aqueous electrolyte is, for example, 10 mass % or less.

(Lithium Salt)

Examples of the lithium salt include: lithium salts of fluorine-containing acid, such as LiPF₆, LiBF₄, and LiCF₃SO₃; and lithium salts of fluorine-containing acid imide, such as LiN(CF₃SO₂)₂. These lithium salts may be used singly or in combination of two or more.

The lithium salt concentration in the non-aqueous electrolyte is, for example, 0.5 to 2 mol/L.

(Others)

The non-aqueous electrolyte has a viscosity at 25° C. of, for example, 3 to 6.5 mPa·s, and preferably 4.5 to 6 mPa·s. When the viscosity of the non-aqueous electrolyte is in such a range, excellent discharge characteristics and excellent rate characteristics can be ensured even at low temperatures. The viscosity can be measured with, for example, a rotary viscometer using a cone plate spindle.

Such non-aqueous electrolyte can suppress the deterioration in ion conductivity and reactivity of charge/discharge reaction at low temperatures, thereby to suppress the deterioration in low-temperature discharge characteristics. In addition, it can inhibit the reaction between the non-aqueous solvent contained in the non-aqueous electrolyte and the positive electrode and/or the negative electrode, thereby to remarkably suppress the gas generation associated with decomposition of the non-aqueous solvent. This can suppress the reduction in charge/discharge capacity and rate characteristics. Furthermore, the non-aqueous electrolyte is low in viscosity and highly capable of wetting the electrodes and separator, and therefore can easily evenly penetrate into the electrodes and separator, which can suppress the local deposition of lithium metal. This consequently can suppress the reduction in battery safety in the event of overcharge. Therefore, it can be suitably used as a non-aqueous electrolyte for non-aqueous electrolyte secondary batteries such as lithium ion secondary batteries.

### [Non-Aqueous Electrolyte Secondary Battery]

The non-aqueous electrolyte secondary battery includes a positive electrode, a negative electrode, a separator interposed therebetween, and the above-described non-aqueous electrolyte.

A detailed description of each component is given below.

(Positive Electrode)

The positive electrode has a positive electrode current collector and a positive electrode active material layer formed on a surface thereof.

Exemplary materials of the positive electrode current collector include stainless steel, aluminum, an aluminum alloy, and titanium.

The positive electrode current collector may be a non-porous electrically conductive substrate, or a porous electrically conductive substrate having a plurality of through-pores. Examples of the non-porous current collector include metal foil and metal sheet. Examples of the porous current collector include metal foil with communicating pores (perforated pores), mesh, punched sheet, and expanded metal.

The thickness of the positive electrode current collector can be selected from the range of, for example, 3 to 50 μm.

The positive electrode active material layer may be formed on one or both surfaces of the positive electrode current collector.

The positive electrode active material layer has a thickness of, for example, 10 to 70 μm.

The positive electrode active material layer contains a positive electrode active material and a binder.

The positive electrode active material may be any known positive electrode active material for non-aqueous electrolyte secondary batteries. Preferred among them are, for example, lithium transition metal oxides having a hexagonal crystal structure, a spinel structure, or an olivine structure. In view of achieving a higher capacity, a hexagonal crystal structure is preferred.

A lithium transition metal oxide having a hexagonal crystal structure is, for example, one represented by the general formula: LiₓM^{a}_{1-y}M^{b}_{y}O₂, where 0.9≦x1.1, 0≦y≦0.7, M^{a} is at least one selected from the group consisting of, for example, Ni, Co, Mn, Fe, and Ti, and M^{b} is at least one metal element other than M^{a}.

In view of achieving a higher capacity, for example, a lithium nickel oxide represented by the general formula: LiₓNi_{1-y}M_{y}O₂, where 0.9≦x≦1.1, 0≦y≦0.7, and M is at least one selected from the group consisting of Co, Mn, Fe, Ti, Al, Mg, Ca, Sr, Zn, Y, Yb, Nb and As is preferable. In the above general formula, y is preferably 0.05≦y≦0.5.

Furthermore, in the present invention, the deposition of metal lithium can be inhibited even in the event of overcharge. Therefore, even though the positive electrode active material is a lithium cobalt oxide having a hexagonal crystal structure, which allows metal lithium to easily deposit during overcharge, the deposition of metal lithium can be effectively inhibited. A preferable example of such a lithium cobalt oxide is one represented by the general formula: LiₓCo_{1-y}M²_{y}O₂, where 0.9≦x≦1.1, 0≦y≦0.7, and M² is at least one selected from the group consisting of Ni, Mn, Fe, Ti Al, Mg, Ca, Sr, Zn, Y, Yb, Nb and As. In the above general formula, y is preferably 0≦y≦0.3.

Examples of the positive electrode active material having a hexagonal crystal structure include: LiNi_{1/2}Mn_{1/2}O₂, LiNiO₂, LiNi_{1/2}Fe_{1/2}O₂, LiNi_{0.8}Co_{0.15}Al_{0.05}O₂, LiNi_{1/3}Mn_{1/3}CO_{1/3}O₂, LiCoO₂, and LiMnO₂.

Examples of the positive electrode active material having a spinel structure include LiMn₂O₄.

Examples of the positive electrode active material having an olivine structure include LiFePO₄, LiCoPO₄, and LiMnPO₄.

These positive electrode active materials may be used singly or in combination of two or more.

Examples of the binder include: fluorocarbon resins, such as polyvinylidene fluoride (PVDF); acrylic resins, such as polymethyl acrylate and ethylene-methyl methacrylate copolymer; and rubbery materials, such as styrene-butadiene rubber, acrylic rubber, and modified products thereof.

The ratio of the binder is, for example, 0.1 to 10 parts by mass, and preferably 1 to 5 parts by mass, relative to 100 parts by mass of the positive electrode active material.

The positive electrode active material layer can be formed by preparing a positive electrode slurry including a positive electrode active material and a binder, and applying the slurry onto a surface of a positive electrode current collector. The positive electrode active material layer may further contain, for example, a thickener and/or an electrically conductive material, if necessary.

The positive electrode slurry usually includes a dispersion medium. A thickener and, further, an electrically conductive material are added to the slurry, if necessary.

Examples of the dispersion medium include water, alcohols such as ethanol, ethers such as tetrahydrofuran, N-methyl-2-pyrrolidone (NMP), and mixed solvents thereof.

The positive electrode slurry can be prepared by, for example, a conventional method using a mixer or kneader. The positive electrode slurry can be applied onto a surface of the positive electrode current collector by, for example, a conventional application method using various coaters. The applied film of positive electrode slurry is usually dried and then pressed. Drying may be natural drying, or drying by heating or under reduced pressure.

Examples of the conductive material include: carbon black; conductive fibers, such as carbon fiber; and fluorinated carbon.

The ratio of the conductive material is, for example, 0.1 to 7 parts by mass, and preferably 1 to 5 parts by mass, relative to 100 parts by mass of the positive electrode active material.

Examples of the thickener include: cellulose derivatives, such as carboxymethyl cellulose (CMC); and poly C₂₋₄alkylene glycols, such as polyethylene glycol.

The ratio of the thickener is, for example, 0.1 to 10 parts by mass, and preferably 1 to 5 parts by mass, relative to 100 parts by mass of the positive electrode active material.

(Negative Electrode)

The negative electrode has a negative electrode current collector and a negative electrode active material layer formed on a surface thereof.

Exemplary materials of the negative electrode current collector include stainless steel, nickel, copper, and a copper alloy.

The form of the negative electrode current collector may be similar to those exemplified for the positive electrode current collector. The thickness of the negative electrode current collector can be selected from the range similar to that of the positive electrode current collector.

The negative electrode active material layer may be formed on one or both surfaces of the negative electrode current collector. The negative electrode active material layer has a thickness of, for example, 10 to 100 μm.

The negative electrode active material layer includes a negative electrode active material as an essential component, and a binder, an electrically conductive material, and/or a thickener as optional components. The negative electrode active material layer may be a deposition film formed by a vapor phase method, or a material mixture layer including a negative electrode active material and a binder, and, if necessary, an electrically conductive material and/or a thickener.

The deposition film can be formed by depositing a negative electrode active material on a surface of the negative electrode current collector by a vapor phase method such as vacuum vapor deposition, sputtering, and ion plating. In this case, silicon, a silicon compound, or a lithium alloy as described hereinafter can be used as the negative electrode active material.

The material mixture layer can be formed by preparing a negative electrode slurry including a negative electrode active material and a binder, and if necessary, an electrically conductive material and/or a thickener, and applying the slurry onto a surface of the negative electrode current collector. The negative electrode slurry usually includes a dispersion medium. A thickener and/or an electrically conductive material is usually added to the negative electrode slurry. The negative electrode slurry can be prepared in accordance with the method of preparing the positive electrode slurry. The negative electrode slurry can be applied by an application method similar to that for the positive electrode.

Examples of the negative electrode active material include: carbon materials; silicon, and silicone compounds; lithium alloys including at least one selected from tin, aluminum, zinc, and magnesium.

Examples of carbon materials include graphite, coke, carbon undergoing graphitization, graphitized carbon fiber, and amorphous carbon. Examples of amorphous carbon include a graphitizable carbon material (soft carbon) that is easily graphitized by heat treatment at a high temperature (e.g., 2800° C.), and a non-graphitizable carbon material (hard carbon) that is hardly graphitized by the heat treatment above. Soft carbon has a graphite-like structure in which fine crystallites are oriented in almost the same direction, while hard carbon has a turbostratic structure.

Examples of silicon compounds include a silicon oxide SiO_{α} where 0.05<α<1.95. α is preferably 0.1 to 1.8, and more preferably 0.15 to 1.6. In the silicon oxide, silicon may be partially substituted by one or two or more elements. Examples of such elements include B, Mg, Ni, Co, Ca, Fe, Mn, Zn, C, N, and Sn.

The negative electrode active material is preferably graphite particles. “Graphite particles” collectively refer to particles including a region having a graphite structure. Accordingly, graphite particles include, for example, natural graphite, artificial graphite, and graphitized mesophase carbon particles. These graphite particles can be used singly or in combination of two or more.

In view of more effectively inhibiting the reductive decomposition of non-aqueous solvent at the negative electrode, graphite particles coated with a water-soluble polymer, as needed, may be used as the negative electrode active material.

The graphite particles preferably have a degree of graphitization of 0.65 to 0.85, and more preferably 0.70 to 0.80.

Here, a value (G) of the degree of graphitization can be determined by subjecting the graphite particles to X-ray diffraction (XRD) analysis, to obtain a value (a₃) of the interplanar spacing d₀₀₂ of the 002 plane, and substituting the obtained value into the following formula:

G=(a₃−3.44)/(−0.086).

The G value is an index showing the degree of graphitization, and indicates how close to the value of d₀₀₂ of a perfect crystal (a₃=3.354) (see KIM KINOSHITA, CARBON, A Wiley-Interscience Publication, pp. 60-61 (1988)).

The graphite particles have an average particle size (D50) of, for example, 5 to 40 μm, preferably 10 to 30 μm, and more preferably 12 to 25 μm.

The average particle size (D50) as used herein means a median size in a volumetric particle size distribution. The average particle size can be measured by, for example, using a laser diffraction/scattering type particle size distribution analyzer (LA-920) available from Horiba, Ltd.

The graphite particles preferably have an average degree of sphericity of 80% or more, and more preferably 85 to 95%. When the average degree of sphericity is in such a range, the slipperiness of graphite particles in the negative electrode active material layer improves, which is advantageous in improving the packability of graphite particles and increasing the bonding strength between graphite particles.

The average degree of sphericity is expressed as 4πS/L²×100 (%), where S is an area of an orthographic projection image of graphite particle, and L is a circumferential length of the orthographic projection image. Preferably, the average value of the degree of sphericity of for example, 100 graphite particles selected at random is in the above range.

The graphite particles have a BET specific surface area of, for example, 2 to 6 m²/g, and preferably 3 to 5 m²/g. When the BET specific surface area is in the above range, the slipperiness of graphite particles in the negative electrode active material layer improves, which is advantageous in increasing the bonding strength between graphite particles. In addition, the preferable amount of water-soluble polymer to coat the surfaces of graphite particles can be reduced.

Examples of the water-soluble polymer to coat the graphite particles include: cellulose derivatives; and poly C₂₋₄alkylene glycols, such as polyacrylic acid, polyvinyl alcohol, polyvinylpyrrolidone, and polyethylene glycol, and derivatives thereof (e.g., substitution products having a substituent, and partial esters). Particularly preferred among them are cellulose derivatives and polyacrylic acid.

Preferable cellulose derivatives are, for example: alkyl celluloses, such as methyl cellulose; carboxyalkyl celluloses, such as CMC; and alkali metal salts of carboxyalkyl celluloses, such as sodium salts of CMC. The alkali metal constituting the alkali metal salts is exemplified by potassium and sodium.

The cellulose derivative preferably has a weight average molecular weight of, for example, 10,000 to 1,000,000. The polyacrylic acid preferably has a weight average molecular weight of, for example, 5,000 to 1,000,000.

In view of optimizing the coverage, the amount of the water-soluble polymer contained in the negative electrode active material layer is, for example, 0.5 to 2.5 parts by mass, and preferably 0.5 to 1.5 parts by mass, relative to 100 parts by mass of the graphite particles.

The coating of the graphite particles with the water-soluble polymer can be performed by any conventional method. For example, in advance of preparing a negative electrode slurry, the graphite particles may be treated with the water-soluble polymer, thereby to coat the surfaces thereof.

The coating of the graphite particles can be performed by, for example, allowing an aqueous solution of the water-soluble polymer to adhere to the graphite particles, and then drying. Alternatively, an aqueous solution of the water-soluble polymer may be mixed with the graphite particles, from which fluid is removed by filtration, followed by drying the solid matter, thereby to coat the graphite particles with the water-soluble polymer. As described above, by drying once, the water-soluble polymer can efficiently adhere to the surfaces of graphite particles, and the coverage of the water-soluble polymer on the graphite particle surface can be increased.

The viscosity at 25° C. of the aqueous water-soluble polymer solution is preferably controlled to 1 to 10 Pa·s. The viscosity is measured with a B-type viscometer, at a rotation speed of 20 mm/s, using a spindle of 5 mmφ.

The amount of the graphite particles to be mixed with 100 parts by mass of the aqueous water-soluble polymer solution is preferably 50 to 150 parts by mass.

The drying temperature is preferably 80 to 150° C. The drying time is preferably 1 to 8 hours.

Next, the graphite particles coated with water-soluble polymer is mixed with a binder and a dispersion medium, thereby to prepare a negative electrode slurry. This process allows the binder to adhere to the surfaces of the graphite particles coated with water-soluble polymer. Since the graphite particles are slippery against each other, the binder adhering to the graphite particle surfaces is subjected to a sufficient shear force, and acts effectively on the graphite particle surfaces.

Examples of the binder, dispersion medium, conductive material, and thickener used for the negative electrode slurry are similar to those exemplified for the positive electrode slurry.

The binder is preferably a particulate one with rubber elasticity. A preferable example of such a binder is a polymer having a styrene unit and a butadiene unit (e.g., styrene-butadiene rubber (SBR)). The polymer as above is excellent in elasticity and is stable at negative electrode potential.

The particulate binder has an average particle size of, for example, 0.1 to 0.3 μm, and preferably 0.1 to 0.25 μm. The average particle size of the binder can be determined, for example, as an average value of the maximum diameter of 10 binder particles measured on their SEM photographs taken with a transmission electron microscope (available from JEOL Ltd., accelerating voltage: 200 kV).

The ratio of the binder is, for example, 0.4 to 1.5 parts by mass, and preferably 0.4 to 1 part by mass, relative to 100 parts by mass of the negative electrode active material. When the graphite particles coated with water-soluble polymer is used as the negative electrode active material, because of good slipperiness between the negative electrode active material particles, the binder adhering to the negative electrode active material particle surfaces is subjected to a sufficient shear force, and acts effectively on the negative electrode active material particle surfaces. Moreover, the particulate binder having a small average particle size contacts the negative electrode active material particle surfaces with high probability. Therefore, the binder, even in a small amount, can sufficiently exert its bonding property.

The amount of the conductive material is not particularly limited, and is, for example, 0 to 5 parts by mass, relative to 100 parts by mass of the negative electrode active material. The amount of the thickener is not particularly limited, and is, for example, 0 to 10 parts by mass, relative to 100 parts by mass of the negative electrode active material.

The negative electrode can be produced in a similar manner to the method preparing the positive electrode. The negative electrode material mixture layer has a thickness of, for example, 30 to 110 μm.

(Separator)

The separator may be a resin microporous film, or a resin non-woven or woven fabric. Examples of the resin constituting the separator include: polyolefins, such as polyethylene and polypropylene; polyamides; polyamide-imides; polyimides; and celluloses.

The separator has a thickness of, for example, 5 to 100 μm.

(Others)

The shape of the non-aqueous electrolyte secondary battery is not particularly limited, and may be, for example, cylindrical, flat, coin-shaped, or prismatic.

The non-aqueous electrolyte secondary battery can be produced by any conventional method, according to the battery shape and other factors. For example, a cylindrical or prismatic battery can be produced by winding a positive electrode, a negative electrode, and a separator interposed therebetween, into an electrode group, and housing the electrode group and a non-aqueous electrolyte in a battery case.

The electrode group is not necessarily a wound one, and may be a stacked or zigzag-folded one. The electrode group may be of a cylindrical shape or a flat shape whose end face perpendicular to the winding axis is oblong, according to the shape of the battery or the battery case.

The material of the battery case may be, for example, aluminum, an aluminum alloy (e.g., an alloy containing a small amount of metal such as manganese and copper), and stainless steel.

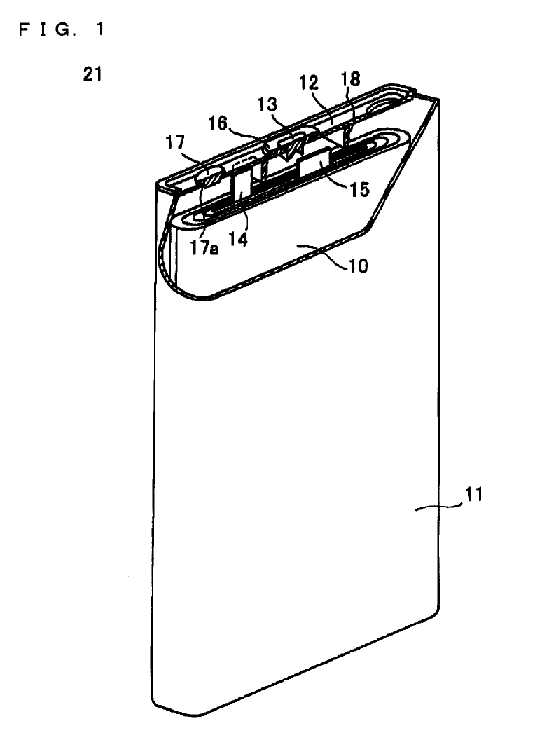

FIG. 1 is a schematic oblique view of a prismatic non-aqueous electrolyte secondary battery according to one embodiment of the present invention. In FIG. 1, a battery 21 is partially cut away to show the configuration of an essential part thereof. The battery 21 is a prismatic battery including a prismatic battery case 11 in which a flat electrode group 10 and a non-aqueous electrolyte (not shown) are housed.

A positive electrode, a negative electrode, and a separator (all not shown) are stacked such that the positive electrode is electrically separated from the negative electrode by the separator, and wound into a wound body. The wound body is pressed from both sides into a flat shape, thereby to form the electrode group 10. One end of a positive electrode lead 14 is connected to a core material of the positive electrode, and the other end thereof is connected to a sealing plate 12 having a function as a positive terminal. One end of a negative electrode lead 15 is connected to a core material of the negative electrode, and the other end thereof is connected to a negative terminal 13. A gasket 16 is disposed between the sealing plate 12 and the negative terminal 13, providing electrical insulation therebetween. Between the sealing plate 12 and the electrode group 10, a frame member 18 made of an electrically insulating material such as polypropylene is usually disposed, thereby to insulate the negative electrode lead 15 from the sealing plate 12.

The sealing plate 12 is joined to the edge of an opening of the prismatic battery case 11, sealing the prismatic battery case 11. The sealing plate 12 is provided with an injection port 17a. The injection port 17a is closed with a sealing plug 17, after the non-aqueous electrolyte is injected into the prismatic battery case 11.

### EXAMPLES

Next, the present invention is specifically described by way of Examples and Comparative Examples. The present invention, however, is not limited to the following Examples.

### Example 1

(a) Production of Negative Electrode

Step (i)

CMC (molecular weight: 400,000), i.e., a water-soluble polymer, was dissolved in water, to obtain an aqueous solution having a CMC concentration of 1.0 mass %. Next, 100 parts by mass of natural graphite particles (average particle size: 20 μm, average degree of sphericity: 0.92, BET specific surface area: 4.2 m²/g) and 100 parts by mass of the aqueous CMC solution were mixed, and stirred while the temperature of the mixture was controlled at 25° C. Thereafter, the mixture was dried at 120° C. for 5 hours, to give a dry mixture. In the dry mixture, the amount of CMC per 100 parts by mass of the graphite particles was 1.0 part by mass.

Step (ii)

The dry mixture was mixed in an amount of 101 parts by mass with 0.6 parts by mass of SBR particles (average particle size: 0.12 μm), 0.9 parts by mass of CMC, and an appropriate amount of water, to prepare a negative electrode slurry. Here, SBR was mixed in the form of an emulsion whose dispersion medium was water (SBR content: 40 mass %), with other components.

Step (iii)

The negative electrode slurry was applied using a die coater onto both surfaces of an electrolytic copper foil (thickness: 12 μm) serving as a negative electrode current collector, and the applied film was dried at 120° C. Thereafter, the dry applied film was pressed between rollers at a linear pressure of 250 kg/cm, thereby to form a negative electrode material mixture layer having a graphite density of 1.5 g/cm³. The overall thickness of the negative electrode was 140 μm. The negative electrode material mixture layer was cut, together with the negative electrode current collector, into a predetermined shape, thereby to produce a negative electrode.

(b) Production of Positive Electrode

To 100 parts by mass of LiNi_{0.80}C_{0.15}Al_{0.05}O₂ serving as a positive electrode active material, 4 parts by mass of PVDF serving as a binder was added, and mixed together with an appropriate amount of NMP, to prepare a positive electrode slurry. The positive electrode slurry was applied using a die coater onto both surfaces of a 20-μm-thick aluminum foil serving as a positive electrode current collector, and the applied film was dried and then pressed, thereby to form a positive electrode material mixture layer. The positive electrode material mixture layer was cut, together with the positive electrode current collector, into a predetermined shape, thereby to produce a positive electrode.

(c) Preparation of Non-Aqueous Electrolyte

LiPF₆ was dissolved at a concentration of 1 mol/L in a mixed solvent containing EC, PC, DEC, FB, and MTMA in a mass ratio M_{EC}:M_{PC}:M_{DEC}:M_{FB}:M_{MTMA}=10:40:40:5:5, thereby to prepare a non-aqueous electrolyte. The viscosity of the non-aqueous electrolyte at 25° C. as measured with a rotary viscometer was 4.8 mPa·s.

(d) Fabrication of Battery

A prismatic non-aqueous electrolyte secondary battery as illustrated in FIG. 1 was fabricated.

The negative electrode and the positive electrode obtained in (a) and (b) above were wound with a 20-μm-thick polyethylene microporous film (A089 (trade name) available from Celgard Inc.) interposed therebetween as a separator, thereby to form an electrode group having an approximately oval cross section. The resultant electrode group and the non-aqueous electrolyte obtained in (c) above were used to fabricate a non-aqueous electrolyte secondary battery illustrated in FIG. 1 in the manner as described hereinbefore. Here, 2.5 g of the non-aqueous electrolyte was injected into the battery case 11 through the injection port 17a of the sealing plate 12. The time taken for injecting the non-aqueous electrolyte was 5 minutes.

### Comparative Example 1

A non-aqueous electrolyte was prepared in the same manner as in Example 1, except that FB was not used, and the DEC content in the non-aqueous solvent was changed to 45 mass %. A battery was fabricated in the same manner as in Example 1, except for using the non-aqueous electrolyte thus prepared.

### Comparative Example 2

A non-aqueous electrolyte was prepared in the same manner as in Example 1, except that MTMA was not used, and the DEC content in the non-aqueous solvent was changed to 45 mass&. A battery was fabricated in the same manner as in Example 1, except for using the non-aqueous electrolyte thus prepared.

### Comparative Example 3

A non-aqueous electrolyte was prepared in the same manner as in Example 1, except that FB and MTMA were not used, and the DEC content in the non-aqueous solvent was changed to 50 mass %. A battery was fabricated in the same manner as in Example 1, except for using the non-aqueous electrolyte thus prepared.

<Battery Evaluation>

The non-aqueous electrolyte secondary batteries of Example and Comparative Examples were subjected to the following evaluation.

### (i) Battery Capacity

The batteries were charged at 25° C. at a constant current of 600 mA, equivalent to 0.7 C, until the battery voltage reached 4.2 V, and then continuously charged at a constant voltage of 4.2 V until the current value reached 50 mA. Thereafter, they were discharged at a constant current of 170 mA, equivalent to 0.2 C, until the battery voltage reached 2.5 V, and the capacity was measured.

### (ii) Evaluation of Cycle Capacity Retention Rate

The batteries were repetitively subjected to a charge/discharge cycle at 45° C. In the charge/discharge cycle, the charge was a constant-current and constant-voltage charge with the maximum current set to 600 mA and the upper limit voltage set to 4.2 V, which was performed for 2 hours and 30 minutes. After the charge, the batteries were left to stand for 10 minutes. The discharge was a constant-current discharge with the discharge current set to 850 mA and the cut-off voltage of discharge set to 2.5 V. After the discharge, the batteries were left to stand for 10 minutes.

With the discharge capacity at the 3^{rd} cycle taken as 100%, the discharge capacity after 500 cycles relative thereto was determined as a cycle capacity retention rate [%].

(iii) Evaluation of Battery Swelling

The batteries were repetitively charged and discharged in the same manner as described in (ii) above, and the thickness perpendicular to the largest plane (50 mm long and 34 mm wide) of each battery was measured at its center portion, after the charge at the 3^{rd} cycle and after the charge at the 501^{th} cycle. The difference between the battery thicknesses thus measured was calculated as a battery swelling amount [mm] after charge/discharge cycles at 45° C.

### (iv) Evaluation of Low-Temperature Discharge Characteristics

The batteries were subjected to three charge/discharge cycles at 25° C. Subsequently, the charge at the 4^{th} cycle was performed at 25° C. Thereafter, the batteries were left to stand for 3 hours at 0° C., and then directly subjected to the discharge at 0° C. With the discharge capacity at the 3^{rd} cycle (25° C.) taken as 100%, the discharge capacity at the 4^{th} cycle (0° C.) was expressed as a percentage, which was regarded as a low-temperature discharge capacity retention rate [%]. Here, the charge and discharge conditions in the charge/discharge cycles were the same as those in (ii) above, except for the standing time after the charge.

### (v) Evaluation of Thermal Stability in the Event of Overcharge

The batteries were subjected to a constant-current charge in a −5° C. environment, with the charge current set to 600 mA and the cut-off voltage set to 4.25 V. Thereafter, the temperature was elevated at a rate of 5° C./min to 130° C., and the batteries were left to stand at 130° C. for 3 hours. The temperature of the battery surface during standing was measured with a thermocouple, to determine a maximum value thereof.

The results of the above evaluation on Example 1 and Comparative Examples 1 to 3 are shown in Table 1, together with the mass ratio of each solvent in the non-aqueous solvent and the time taken for injecting the non-aqueous electrolyte.

TABLE 1

| | | | | | Battery | Low- | |
|---|---|---|---|---|---|---|---|
| | | | | Cycle | swelling | temperature | |
| | EC:PC:DEC: | Injection | Battery | capacity | after | discharge | Thermal |
| | FB:MTMA | time | capacity | retention | cycles | characteristics | stability |
| | mass ratio | (min) | (mAh) | rate (%) | (mm) | (%) | (° C.) |
| Ex. 1 | 10:40:40:5:5 | 5 | 850 | 86.7 | 0.39 | 81.9 | 131 |
| Com. | 10:40:45:0:5 | 6 | 850 | 86.1 | 0.40 | 73.6 | 170 |
| Ex. 1 | | | | | | | |
| Com. | 10:40:45:5:0 | 8 | 850 | 83.0 | 0.47 | 73.9 | 164 |
| Ex. 2 | | | | | | | |
| Com. | 10:40:50:0:0 | 15 | 850 | 80.5 | 0.56 | 68.0 | 172 |
| Ex. 3 | | | | | | | |

As evident from Table 1, in the batteries of Comparative Examples 1 to 3 using a non-aqueous electrolyte that contained no carboxylic acid ester and/or no fluoroarene, it took a long time to inject the non-aqueous electrolyte, and the discharge characteristics at low temperatures and the thermal stability were low. In Comparative Examples 2 and 3 that contained no carboxylic acid ester, in which the penetration of the non-aqueous electrolyte was particularly poor, it took a longer time to inject the non-aqueous electrolyte.

In the batteries of Comparative Examples 1 and 3 using a non-aqueous electrolyte that contained no fluoroarene, the battery temperature in the event of overcharge was very high, which was presumably because the deposited lithium was failed to be stabilized. In Comparative Example 2 using a non-aqueous electrolyte that contained a fluoroarene but contained no carbonic acid ester, the battery temperature in the event of overcharge was somewhat low, as compared with Comparative Examples 1 and 3. However, presumably because the effect of the fluoroarene was not exerted effectively, the battery temperature exceeded 160° C.

In contrast to the results of Comparative Examples, in the battery of Example 1, the non-aqueous electrolyte was injected in a short time, the battery temperature in the event of overcharge was low, and the discharge characteristics at low temperatures were high.

### Examples 2 to 6

Non-aqueous electrolytes were prepared in the same manner as in Example 1, except that the MTMA content was changed as shown in Table 2. Batteries were fabricated in the same manner as in Example 1, except for using the non-aqueous electrolytes thus prepared. The time taken for injecting the non-aqueous electrolyte was measured, and the battery evaluation was performed. The results are shown in Table 2.

TABLE 2

| | | | | | Battery | Low- | |
|---|---|---|---|---|---|---|---|
| | | | | Cycle | swelling | temperature | |
| | | Injection | Battery | capacity | after | discharge | Thermal |
| | MTMA | time | capacity | retention | cycles | characteristics | stability |
| | (mass %) | (min) | (mAh) | rate (%) | (mm) | (%) | (° C.) |
| Ex. 2 | 1.5 | 8 | 850 | 82.5 | 0.46 | 76.6 | 161 |
| Ex. 3 | 2 | 7 | 850 | 85.2 | 0.42 | 80.1 | 135 |
| Ex. 1 | 5 | 5 | 850 | 86.7 | 0.39 | 81.9 | 131 |
| Ex. 4 | 15 | 4 | 850 | 83.3 | 0.45 | 82.2 | 132 |
| Ex. 5 | 25 | 4 | 850 | 80.8 | 0.48 | 82.5 | 134 |
| Ex. 6 | 30 | 4 | 850 | 64.4 | 0.80 | 82.8 | 134 |

In all Examples, the low-temperature discharge characteristics were high. Particularly in Examples 1 and 3 to 5, gas generation was suppressed, and the cycle capacity retention rate was high. Moreover, the discharge characteristics at low temperatures were high, and the increase in battery temperature in the event of overcharge was suppressed.

When the carboxylic acid ester content was low, the thermal stability tended to be lowered, the penetration of the non-aqueous electrolyte tended to be poor, and the time taken for injecting the non-aqueous electrolyte tended to be prolonged. Therefore, in view of the thermal stability and the ease of injection, it is preferable to set the carboxylic acid ester content to more than 1.5 mass % (e.g., equal to or more than 2 mass %). On the other hand, when the carboxylic acid ester content was high, the gas generation tended to increase. Therefore, in view of suppressing the gas generation, it is preferable to set the carboxylic acid ester content to less than 30 mass % (e.g., equal to or less than 25 mass %).

### Examples 7 to 10 and Comparative Example 4

Non-aqueous electrolytes were prepared in the same manner as in Example 1, except that the FB content was changed as shown in Table 3. Batteries were fabricated in the same manner as in Example 1, except for using the non-aqueous electrolytes thus prepared. The time taken for injecting the non-aqueous electrolyte was measured, and the battery evaluation was performed. The results are shown in Table 3.

TABLE 3

| | | | | | Battery | Low- | |
|---|---|---|---|---|---|---|---|
| | | | | Cycle | swelling | temperature | |
| | | Injection | Battery | capacity | after | discharge | Thermal |
| | FB | time | capacity | retention | cycles | characteristics | stability |
| | (mass %) | (min) | (mAh) | rate (%) | (mm) | (%) | (° C.) |
| Ex. 7 | 1.5 | 6 | 850 | 85.7 | 0.41 | 81.1 | 163 |
| Ex. 8 | 2 | 5 | 850 | 86.2 | 0.40 | 81.7 | 135 |
| Ex. 1 | 5 | 5 | 850 | 86.7 | 0.39 | 81.9 | 131 |
| Ex. 9 | 15 | 4 | 850 | 84.2 | 0.43 | 80.8 | 131 |
| Ex. 10 | 25 | 4 | 850 | 80.5 | 0.48 | 80.1 | 131 |
| Com. | 30 | 4 | 850 | 58.7 | 0.62 | 69.0 | 131 |
| Ex. 4 | | | | | | | |

In Examples 1 and 7 to 10, the low-temperature discharge characteristics were high. Particularly in Examples 1 and 8 to 10, gas generation was suppressed, and the cycle capacity retention rate was high. Moreover, the discharge characteristics at low temperatures were high, and the increase in battery temperature in the event of overcharge was effectively suppressed.

When the fluoroarene content exceeded 25 mass %, a considerable amount of gas was generated, and the cycle capacity retention rate was significantly reduced (Comparative Example 4). In addition, the discharge characteristics at low temperatures were significantly lowered. When the fluoroarene content was low, the battery temperature in the event of overcharge tended to increase. In view of suppressing the reduction in thermal stability in the event of overcharge, it is preferable to set the fluoroarene content to more than 1.5 mass % (e.g. equal to or more than 2 mass %).

### Examples 11 to 18 and Comparative Examples 5 to 8

Non-aqueous electrolytes were prepared in the same manner as in Example 1, except that the EC:PC:DEC mass ratio was changed as shown in Table 4. Batteries were fabricated in the same manner as in Example 1, except for using the non-aqueous electrolytes thus prepared. The time taken for injecting the non-aqueous electrolyte was measured, and the battery evaluation was performed. The results are shown in Table 4.

TABLE 4

| | | | | | Battery | Low- | |
|---|---|---|---|---|---|---|---|
| | | | | Cycle | swelling | temperature | |
| | EC:PC:DEC: | Injection | Battery | capacity | after | discharge | Thermal |
| | FB:MTMA | time | capacity | retention | cycles | characteristics | stability |
| | mass ratio | (min) | (mAh) | rate (%) | (mm) | (%) | (° C.) |
| Com. | 3:43.5:43.5:5:5 | 5 | 820 | 36.0 | 0.98 | 55.2 | 135 |
| Ex. 5 | | | | | | | |
| Ex. 11 | 5:42.5:42.5:5:5 | 5 | 850 | 80.7 | 0.48 | 76.7 | 134 |
| Ex. 12 | 35:27.5:27.5:5:5 | 20 | 850 | 80.3 | 0.49 | 77.4 | 135 |
| Com. | 40:25:25:5:5 | 30 | 850 | 45.5 | 0.95 | 66.0 | 170 |
| Ex. 6 | | | | | | | |
| Ex. 13 | 30:0:60:5:5 | 5 | 850 | 78.5 | 0.53 | 81.8 | 131 |
| Ex. 14 | 30:1:59:5:5 | 5 | 850 | 80.1 | 0.49 | 81.0 | 131 |
| Ex. 15 | 6:60:24:5:5 | 20 | 850 | 80.3 | 0.48 | 77.5 | 131 |
| Com. | 4:70:16:5:5 | 30 | 850 | 53.6 | 0.87 | 63.3 | 131 |
| Ex. 7 | | | | | | | |
| Com. | 30:55:5:5:5 | 30 | 850 | 69.2 | 0.60 | 65.0 | 131 |
| Ex. 8 | | | | | | | |
| Ex. 16 | 30:50:10:5:5 | 25 | 850 | 80.6 | 0.47 | 75.8 | 131 |
| Ex. 17 | 20:10:60:5:5 | 5 | 850 | 80.2 | 0.48 | 82.4 | 132 |
| Ex. 18 | 10:10:70:5:5 | 5 | 850 | 68.6 | 0.55 | 81.1 | 132 |

As shown in Table 4, in all Examples, the low-temperature discharge characteristics were high. Particularly in Examples 11, 12, 14 and 15 to 17, gas generation was effectively suppressed, and the cycle capacity retention rate was high. Moreover, the deterioration in discharge characteristics at low temperatures and the increase in battery temperature in the event of overcharge were effectively suppressed.

In Comparative Examples 5 and 7, in which the EC content was less than 4.7 mass %, presumably due to the reduced ion conductivity, the discharge characteristics at low temperatures were degraded. Furthermore, presumably due to the increased relative ratios of the other solvents, a considerable amount of gas was generated, and as a result, the cycle capacity retention rate was lowered significantly. In Comparative Example 7, due to the high viscosity of the non-aqueous electrolyte, the time taken for injecting the non-aqueous electrolyte was prolonged, and the discharge characteristics at low temperatures were degraded. In addition, presumably because PC was decomposed significantly, the amount of gas generated was increased, and thereby the cycle capacity retention rate was lowered.

In Comparative Example 6, in which the EC content exceeded 37 mass %, the battery temperature in the event of overcharge increased significantly. Moreover, due to the high viscosity of the non-aqueous electrolyte, the time taken for electrolyte injection was prolonged, and the discharge characteristics at low temperatures were degraded. In addition, a considerable amount of gas was generated, and the cycle capacity retention rate was significantly lowered.

When the non-aqueous solvent included no PC, the amount of gas generated tended to increase, although slightly. Therefore, in view of suppressing the gas generation, the non-aqueous solvent preferably includes PC. In addition, the PC content in the non-aqueous solvent is preferably set to equal to or more than 1 mass %. From the results of Comparative Example 7, the PC content is preferably set to less than 70 mass % (e.g., equal to or less than 60 mass %).

In Comparative Example 8, in which the chain carbonate content was 5 mass %, due to the high viscosity of the non-aqueous electrolyte, the time taken for electrolyte injection was prolonged, and the discharge characteristics at low temperatures were degraded. In addition, a considerable amount of gas was generated, and the cycle capacity retention rate was lowered. When the chain carbonate content was high, the amount of gas generated tended to increase. Therefore, in view of suppressing the gas generation, the chain carbonate (particularly, DEC) content is preferably set to less than 70 mass % (e.g., equal to or less than 60 mass %).

### Examples 19 to 25

Non-aqueous electrolytes were prepared in the same manner as in Example 1, except that carbonic acid esters as shown in Table 5 were used in place of MTMA. Batteries were fabricated in the same manner as in Example 1, except for using the non-aqueous electrolytes thus prepared. The time taken for injecting the non-aqueous electrolyte was measured, and the battery evaluation was performed. The results are shown in Table 5.

TABLE 5

| | | | | | Battery | Low- | |
|---|---|---|---|---|---|---|---|
| | | | | Cycle | swelling | temperature | |
| | | Injection | Battery | capacity | after | discharge | Thermal |
| | | time | capacity | retention | cycles | characteristics | stability |
| | Carbonic acid ester | (min) | (mAh) | rate (%) | (mm) | (%) | (° C.) |
| Ex. 19 | 2,2-dimethyl | 4 | 850 | 85.2 | 0.43 | 81.4 | 131 |
| | butyric acid methyl | | | | | | |
| Ex. 20 | 2-ethyl-2-methyl | 4 | 850 | 81.0 | 0.45 | 80.4 | 131 |
| | butyric acid methyl | | | | | | |
| Ex. 21 | Ethyl | 4 | 850 | 84.9 | 0.46 | 80.6 | 131 |
| | trimethylacetate | | | | | | |
| Ex. 22 | Propyl | 4 | 850 | 81.3 | 0.49 | 80.0 | 131 |
| | trimethylacetate | | | | | | |
| Ex. 23 | Methyl propionate | 3 | 850 | 38.0 | 1.10 | 83.6 | 131 |
| Ex. 24 | Methyl butyrate | 3 | 850 | 55.2 | 0.97 | 82.2 | 131 |
| Ex. 25 | Methyl isobutyrate | 5 | 850 | 57.7 | 0.88 | 81.4 | 131 |

Table 5 shows that in any case where the carbonic acid esters above were used, the discharge characteristics at low temperatures were improved, and the increase in battery temperature in the event of overcharge was effectively suppressed, like in Example 1. Table 5 also shows a tendency in which, among carbonic acid esters, a branched-chain alkane carboxylic acid ester can be used to more effectively suppress the gas generation. Particularly when the carbon atom in the alkyl group bound to the carbonyl group of the carbonic acid ester was a tertiary carbon atom, results similar to those of Example 1 using methyl pivalate were obtained. Specifically, the discharge characteristics at low temperatures were high, and in addition, the non-aqueous electrolyte was injected in a short time, and the amount of gas generated was small (Examples 19 to 22).

### Examples 26 to 29

Non-aqueous electrolytes were prepared in the same manner as in Example 1, except that fluoroarenes as shown in Table 6 were used in place of FB. Batteries were fabricated in the same manner as in Example 1, except for using the non-aqueous electrolytes thus prepared. The time taken for injecting the non-aqueous electrolyte was measured, and the battery evaluation was performed. The results are shown in Table 6.

TABLE 6

| | | | | Cycle | Battery | Low- | |
|---|---|---|---|---|---|---|---|
| | | | | capacity | swelling | temperature | |
| | | Injection | Battery | retention | after | discharge | Thermal |
| | | time | capacity | rate | cycles | characteristics | stability |
| | Fluoroarene | (min) | (mAh) | (%) | (mm) | (%) | (° C.) |
| Ex. 26 | 1,4-difluorobenzene | 5 | 850 | 86.7 | 0.39 | 81.9 | 133 |
| Ex. 27 | 1,4,6-trifluorobenzene | 5 | 850 | 82.3 | 0.43 | 81.2 | 134 |
| Ex. 28 | 4-fluorotoluene | 6 | 850 | 84.0 | 0.46 | 80.8 | 135 |
| Ex. 29 | 3,5-difluorotoluene | 6 | 850 | 81.9 | 0.48 | 80.1 | 135 |

In Examples 26 to 29 using the fluoroarenes above, effects similar to those of Example 1 using FB were obtained.

### Examples 30 to 37

Positive electrodes were produced and non-aqueous electrolytes were prepared in the same manner as in Example 1, except that positive electrode active materials as shown in Table 7 were used, and the mass ratio of each solvent was changed as shown in Table 7. Batteries were fabricated in the same manner as in Example 1, except for using the positive electrodes and non-aqueous electrolytes thus prepared, and were subject to the evaluation. The results are shown in Table 7.

TABLE 7

| | | | | | Battery | Low- | |
|---|---|---|---|---|---|---|---|
| | | | | Cycle | swelling | temperature | |
| | | EC:PC:DEC: | Battery | capacity | after | discharge | Thermal |
| | Positive electrode | FB:MTMA | capacity | retention | cycles | characteristics | stability |
| | active material | mass ratio | (mAh) | rate (%) | (mm) | (%) | (° C.) |
| Ex. 30 | LiNi_{0.80}Co_{0.15}Al_{0.05}O₂ | 10:50:30:5:5 | 850 | 86.3 | 0.38 | 81.5 | 131 |
| Ex. 31 | LiNi_{1/3}Co_{1/3}Mn_{1/3}O₂ | 30:20:40:5:5 | 850 | 87.0 | 0.33 | 82.0 | 131 |
| Ex. 32 | LiCoO₂ | 30:20:30:5:15 | 850 | 87.1 | 0.35 | 81.7 | 131 |
| Ex. 33 | LiCoO₂ | 30:1:54:5:10 | 850 | 88.5 | 0.32 | 83.3 | 135 |
| Ex. 34 | LiNi_{0.3}Co_{0.7}O₂ | 30:20:40:5:5 | 850 | 85.3 | 0.36 | 81.4 | 131 |
| Ex. 35 | LiNi_{0.80}Co_{0.15}Mg_{0.05}O₂ | 10:50:30:5:5 | 850 | 85.9 | 0.39 | 80.3 | 132 |
| Ex. 36 | LiNi_{0.3}Mn_{0.7}O₂ | 30:20:40:5:5 | 850 | 83.3 | 0.43 | 80.2 | 133 |
| Ex. 37 | LiNi_{0.5}Mn_{0.5}O₂ | 20:20:50:5:5 | 850 | 82.0 | 0.47 | 80.0 | 132 |

Table 7 shows that any of the positive electrode active materials above can be used to produce effects similar to those of Example 1.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

According to the non-aqueous electrolyte of the present invention, the decomposition of the non-aqueous solvent and the gas generation associated therewith can be suppressed, which makes it possible to maintain excellent discharge characteristics even at low temperatures, as well as to improve the safety in the event of overcharge. It is therefore useful as a non-aqueous electrolyte for secondary batteries used in electronic equipment such as cellular phones, personal computers, digital still cameras, game machines, and portable audio devices.

### REFERENCE SIGNS LIST

10: Electrode group, 11: Prismatic battery case, 12: Sealing plate, 13: Negative terminal, 14: Positive electrode lead, 15: Negative electrode lead, 16: Gasket, 17: Sealing plug, 17a: Injection port, 18: Insulating frame member, 21: Non-aqueous electrolyte secondary battery

1. A non-aqueous electrolyte for secondary batteries, comprising a non-aqueous solvent, and a lithium salt dissolved in the non-aqueous solvent,
the non-aqueous solvent including a cyclic carbonate, a chain carbonate, a fluoroarene, and a carboxylic acid ester,
the cyclic carbonate including ethylene carbonate,
the non-aqueous solvent having:
a cyclic carbonate content M_{CI} being 4.7 to 90 mass %,
an ethylene carbonate content M_{EC} being 4.7 to 37 mass %,
a chain carbonate content M_{CH} being 8 to 80 mass %,
a fluoroarene content M_{FA} being 1 to 25 mass %, and
a carboxylic acid ester content M_{CAE} being 1 to 80 mass %.

2. The non-aqueous electrolyte for secondary batteries according to claim 1, wherein the carboxylic acid ester includes a branched-chain alkane carboxylic acid ester.

3. The non-aqueous electrolyte for secondary batteries according to claim 1, wherein the carboxylic acid ester includes a branched-chain alkane carboxylic acid ester represented by the following formula (1) 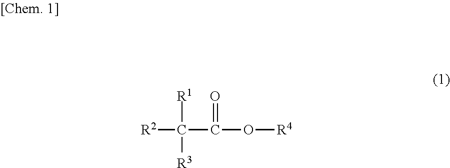
where R¹ to R⁴ independently represent a C₁₋₄alkyl group or a halogenated C₁₋₄alkyl group, and R¹ to R⁴ have 4 to 8 carbon atoms in total.

4. The non-aqueous electrolyte for secondary batteries according to claim 3, wherein in the formula (I), R¹ to R⁴ independently represent a C₁₋₂alkyl group or a halogenated C₁₋₂alkyl group.

5. The non-aqueous electrolyte for secondary batteries according to claim 1, wherein the carboxylic acid ester includes methyl pivalate.

6. The non-aqueous electrolyte for secondary batteries according to claim 1, wherein in the non-aqueous solvent,
the cyclic carbonate content M_{CI} is 5 to 90 mass %,
the ethylene carbonate content M_{CI} is 5 to 35 mass %,
the fluoroarene content M_{FA} is 2 to 25 mass %, and
the carboxylic acid ester content M_{CAE} is 1.8 to 40 mass %.

7. The non-aqueous electrolyte for secondary batteries according to claim 1, wherein the cyclic carbonate further includes propylene carbonate.

8. The non-aqueous electrolyte for secondary batteries according to claim 7, wherein a propylene carbonate content M_{PC} in the non-aqueous solvent is 1 to 60 mass %.

9. The non-aqueous electrolyte for secondary batteries according to claim 1, wherein the chain carbonate further includes diethyl carbonate.

10. The non-aqueous electrolyte for secondary batteries according to claim 9, wherein a diethyl carbonate content M_{DEC} in the non-aqueous solvent is 10 to 60 mass %.

11. The non-aqueous electrolyte for secondary batteries according to claim 1, wherein the fluoroarene is at least one selected from the group consisting of fluorobenzenes and flurotoluenes.

12. A non-aqueous electrolyte secondary battery comprising:
a positive electrode having a positive electrode current collector, and a positive electrode active material layer formed on a surface of the positive electrode current collector;
a negative electrode having a negative electrode current collector, and a negative electrode active material layer formed on a surface of the negative electrode current collector;
a separator interposed between the positive electrode and the negative electrode; and
the non-aqueous electrolyte for secondary batteries of claim 1.

13. The non-aqueous electrolyte secondary battery according to claim 12, wherein:
the positive electrode active material layer includes as a positive electrode active material, a lithium nickel oxide represented by the general formula: LiₓNi_{1-y}M¹_{y}O₂ where 0.9≦x≦1.1, 0≦y≦0.7, and M¹ is at least one selected from the group consisting of Co, Mn, Fe, Ti, Al, Mg, Ca, Sr, Zn, Y, Yb, Nb, and As;
the cyclic carbonate further includes propylene carbonate; and
a propylene carbonate content M_{PC} in the non-aqueous solvent is 30 to 60 mass %.

14. The non-aqueous electrolyte secondary battery according to claim 12, wherein:
the positive electrode active material layer includes as a positive electrode active material, a lithium cobalt oxide represented by the general formula: LiₓCo_{1-y}M²_{y}O₂, where 0.9≦x≦1.1. 0≦y≦0.7, and M² is at least one selected from the group consisting of Ni, Mn, Fe, Ti, Al, Mg, Ca, Sr, Zn, Y, Yb, Nb and As;
the cyclic carbonate further includes propylene carbonate; and
a propylene carbonate content M_{PC} in the non-aqueous solvent is 1 to 40 mass %.

15. The non-aqueous electrolyte secondary battery according to claim 12, wherein the negative electrode active material layer includes graphite particles as a negative electrode active material.

16. The non-aqueous electrolyte secondary battery according to claim 15, wherein surfaces of the graphite particles are coated with at least one selected from the group consisting of cellulose derivatives and polyacrylic acids.
